(19) United States
(12) Patent Application Publication
(10) Pub. No.: US 2008/0257873 A1
(43) Pub. Date: Oct. 23, 2008

(54) Method for Producing Two-Dimensional Periodic Structures in a Polymeric Medium

(76) Inventors: Christophe Hubert, Troyes (FR); Celine Fiorini-Debuisschert, Orsay (FR); Jean-Michel Nunzi, Murs Erigne (FR)

Correspondence Address: Blakely Sokoloff Taylor & Zafman, 12400 Wilshire Boulevard, 7th Floor, Los Angeles, CA, 90025, US

(21) Appl. No.: 11/587,443

(22) PCT Filed: Apr. 22, 2005
(86) PCT No.: PCT/FR05/01001

§ 371 Date: Oct. 23, 2006

(30) Foreign Application Priority Data
Apr. 23, 2004 (FR) 0404332

(51) Int. Cl. B23K 26/06; B82B 3/00; B23K 26/08; B23K 26/40

(52) U.S. Cl. 219/121.68; 219/121.82; 219/121.85; 219/121.74

(57) ABSTRACT

A method for producing periodic structures at the surface of a sol-gel type, hybrid organic-inorganic or organic material, characterised in that it includes the step of directly illuminating the material with a laser beam having a uniform intensity profile at near-normal incidence, while moving said material and said laser beam relative to each other.

### AREA OF THE INVENTION

The sphere of the present invention relates to the fabrication of periodic structures on the surface of some organic materials, such as polymers.

### PRIOR ART

The possible organizing of organic materials or hybrid organic-inorganic materials on sub-microscopic (and nanoscopic) scale opens up numerous prospects of interest in particular, but not limited to, the producing of data functions for example or the optimisation of the optical properties (e.g. modulation of absorption/emission, modulation of wave propagation properties . . . ) or the electronic properties of these materials.

Among possible applications, the development may be mentioned of electro-optical modulators for optical processing of signals (in telecommunications), the producing of organic lasers and more generally the entire plastic electronics domain: e.g. the design and optimisation of photovoltaic cells, the optimisation of light-emitting diodes . . . .

More specifically, for optical effects e.g. the structuring of matter on sub-wavelength scale makes it possible to contemplate the use of new effects, such as the possible total control of light emission in photonic crystals . . . . Another example of application concerns the obtaining of light coupling and uncoupling functions in photonic systems, such as organic light-emitting diodes for example (OLEDS). In an OLED approximately 80% of the light emitted by the light-emitting material is lost through a guiding effect in the different layers. When structuring the diode, i.e. by inserting a one-dimensional network therein for example, it has been shown that it is possible to reduce the quantity of light lost through guiding [1]. This is due to Bragg diffraction on the network of waves which are initially guided into different layers of the diode.

A distinction can be made between two types of structuring known in the prior art: the first relates to volume structuring (the case with photonic crystals for example), the second relates to surface structuring (the case with diffraction networks for example).

The present invention concerns the second, namely surface structuring.

Known structuring methods can be classified into two categories: the first groups together optical lithography (photolithography) and electronic lithography (these techniques are chiefly used in the semiconductor industry [2]), the second groups together so-called “contact” methods such those termed “embossing” and “stamping”.

Amongst the numerous, known reproduction techniques, photolithography belongs to those techniques that have been given more extensive development. The main steps involved in photolithography are the following: exposing a sensitive material (e.g. polymer resin) to a beam of photons having wavelengths in the visible UV or X-ray range, according to type of apparatus and desired resolution, through a mask comprising the pattern to be written, developing this material and then etching. Although lithographic methods are fully mastered today, they have some shortcomings of which the following may be cited:
complex experimental set up
the need to use several steps (insulation, development, etching) before obtaining the final pattern,
the need for great stability and precise alignment of the different elements (mask and sample) in order to reproduce the initial pattern with the utmost precision,
the need for a dust-free environment, even of clean room type.

In parallel to the different lithographic methods, others methods have been developed based on the replication of masks via physical contact. These techniques have the advantage of requiring low financial investment, and are easy to implement. These methods are based on the use of a mask or mould whose patterns are transferred to a substrate by contact or pressure. However, the use of such techniques is often limited by the availability of suitable masks which themselves are chiefly made using lithographic techniques having the above-mentioned shortcomings. In addition, it is to be noted that the average resolution of these contact techniques still remains lower than with lithographic techniques.

Within this contact, it therefore appears useful to arrive at developing new, non-photolithographic, techniques for micro and nanostructuring to complement already existing techniques. Industry in particular has a demand for techniques requiring a fewer number of steps but not requiring an environment of clean room type, and hence less costly.

The fabrication of single or multidirectional structures by laser radiation of certain materials in thin layers on small surfaces (in the order of the diameter of the laser beam i.e. in the order of a few mm²) is known.

Recently, it has been evidenced that the irradiation of azoic polymer films by modulating the intensity derived from one or more beams leads directly to controlled topographical modification of the film surface and to the formation of a surface network [3,4]. This technique has the advantage of being low cost through the use of all-optical structuring means. Compared with lithographic techniques this method, based on a phenomenon of conveyed photoinduced matter, is direct and does not require any post-treatment of “development/dissolution” type.

However, it is only possible with this method to simply obtain one-dimensional networks. The producing of two-dimensional structures proves to be delicate since it requires the producing of more complex interference figures which are difficult to implement. In addition, several constraints have to be considered when producing these structures, among which mention may be made of the fact that:
the difference in optical pathway between each interfering beam on the surface of the material must be less than the coherence length of the laser,
precise adjustments must be made to obtain spatial covering of the two beams on the surface of the polymer film, these beams also having to be of the same intensity, and
the sample must not move during the experiment to avoid blurring the interface figure.

Another method for producing structures is to illuminate the material with single laser beam of sufficient intensity that is pulsed or continuous. This method which has several properties in common with Wood's anomalies occurring in diffraction networks [5] was put to advantage in a so-called LIPS process (Laser Induced Periodic Structure) [6]. This structuring process was evidenced on the surface of materials (inorganic or organic) irradiated under oblique incidence by a polarised laser beam. However, in the different LIPS examples described in the literature, only the observation of fringes on the surface of the material is described i.e. one-dimensional structures.

Similarly, it has been shown that it is also possible using a single laser beam to create periodic structures directly of sub-micronic size that are not one-dimensional but two-dimensional on the surface of organic materials [7,8]. This method, differing from the previous one through the physical processes involved, require normal incidence of the laser beam on the material. However, the surface of the area able to be structured is limited to the diameter of the laser beam used, i.e. a few mm², and the geometry of the induced structures is as yet ill mastered.

Side shifting of the laser beam to successively irradiate adjacent areas of the material does not make it possible to ensure pattern continuity of the structures on the areas covered by the beam. These discontinuities may lead to defects for optical coupling/uncoupling applications in particular.

### OBJECT OF THE INVENTION

The main purpose of the invention is to provide a novel method with which to improve the fabrication of periodic structures on the surface of some materials, such as polymers or hybrid organic-inorganic materials of sol-gel type.

The present invention chiefly sets out to provide a method that is easy to implement allowing the fabrication of said structures on large surfaces.

### SUBJECT OF THE INVENTION

The above object is achieved by the present invention through a method comprising a step which consists of directly illuminating an organic material or hybrid organic-inorganic material of sol-gel type, with a laser beam having a uniform intensity profile under near-normal incidence, whilst causing relative movement between said material and the laser beam, preferably in the form of relative rotation.

After lengthy research and experimenting, the inventors have discovered, in surprising, unforeseeable manner, that the above-mentioned inventive method allows the creation of one- or two-dimensional structures in a single step on surfaces of organic materials possibly reaching several cm², while using only one same laser beam. They have found that the relative mechanical movement between the laser beam and the irradiated material, instead of blurring any interference effects and reducing structure modulation, surprisingly makes it possible to obtain periodic structures continuously covering the entire irradiated surface during the movement, i.e. several cm² for example.

### DESCRIPTION OF THE FIGURES

Other characteristics, objects and advantages of the present invention will become apparent on reading the following detailed description with reference to the appended figures given as non-limiting examples, in which:

FIG. 1 schematically shows the assembly of the present invention allowing the writing of photoinduced structures on the surface of organic or hybrid films,

FIG. 2 shows a variant of implementation of the present invention,

FIG. 3 schematizes the structure of molecules able to be given preferred use under the present invention, and

FIGS. 4, 5 and 6 are images taken under atomic force microscopy (AFM) of sample structures obtained with the present invention, the images in FIGS. 4 and 5 being obtained using the DOPRMA/MMA copolymer, and the image in FIG. 6 being obtained using the DRIMA/MMA copolymer.

### DETAILED DESCRIPTION OF THE INVENTION

The structuring method of the present invention essentially consists of illuminating under near-normal incidence, using a laser beam with uniform intensity distribution, either a polymer film or a hybrid film having relative movement with respect to the laser beam, most preferably in rotation.

Under the present invention, by “near-normal” is meant an angle of incidence of less than 5° with respect to the normal to the material.

Evidently, said rotational movement may be replaced by any equivalent relative movement between the laser beam and the material to be irradiated. Also, as a variant, it could be considered to move the laser beam or to cause movement both of the laser beam and of the polymer material.

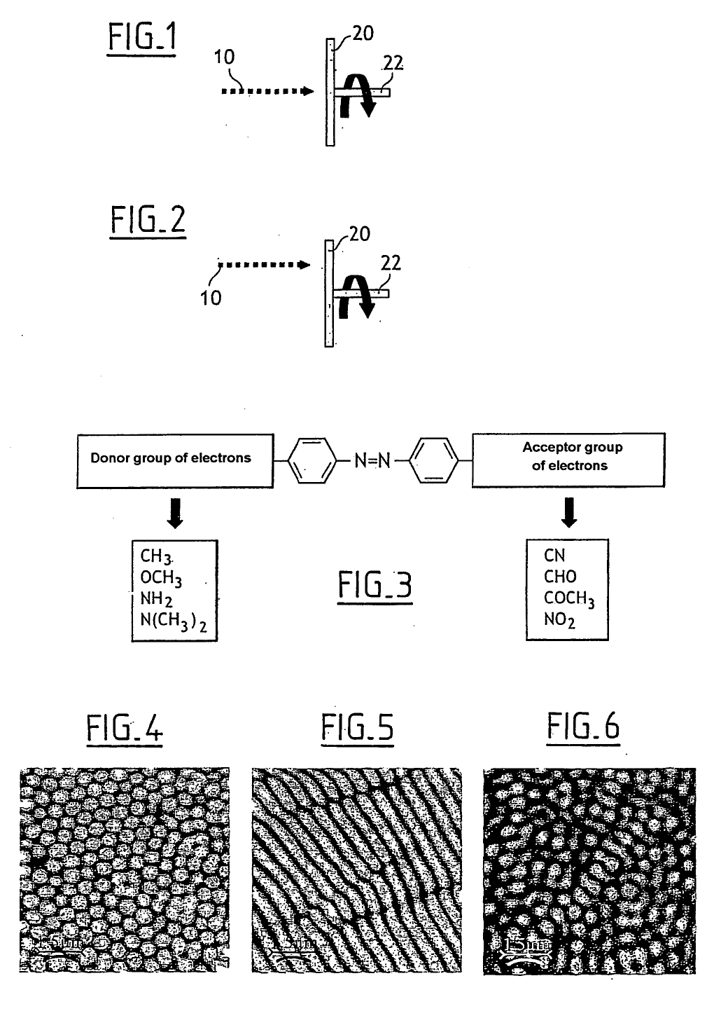

In appended FIG. 1, 10 represents an incident laser beam and 20 a support plate for the material irradiated by the laser beam 10. The polymer material may for example be in the form of a polymer film carried by a glass substrate. The laser beam 10 is directed perpendicular to the surface of the polymer material. The support 20 is provided with a spindle 22 able to be driven in rotation by a suitable motor.

More precisely, according to the embodiment illustrated FIG. 1, the laser beam 10 is centred on the rotational axis of the support 20.

The writing process typically takes place at room temperature.

It can however be conducted at higher temperatures, in particular for materials having high glass transition temperatures.

The intensity of the laser beam 10 may vary, typically between 0.2 and 2 Watts/cm².

The polymer materials used for the present invention consist of a polymer backbone onto which absorbent molecules are grafted. Several types of copolymers may be used, differing from one another through the type of polymer backbone but also through the dye molecules used. For hybrid materials, the backbone generally contains silicon atoms.

The laser wavelength must lie between the absorption band of the molecule used or close to this absorption band. Under the present invention, by “close to the absorption band” is meant a wavelength whose difference with respect to the lower limit of the band does not exceed 100 nm.

The polymer materials used may be in the form of films deposited on a substrate. The deposits may be made for example by centrifuging a solution consisting of a copolymer dissolved in a solvent. The present invention also extends to the use of “solid” materials in various forms (cylinders, cubes . . . ) which may be obtained using any means, e.g. but not limited to moulding followed by polishing a solid, copolymerized mixture.

FIG. 2 schematizes a variant of embodiment in which the laser beam 10 of near-normal incidence is offset with respect to the axis of rotation of the irradiated polymer material, while remaining parallel to this axis of rotation.

### EXAMPLES OF EMBODIMENT

With respect to FIGS. 4, 5 and 6 three examples of results are described, obtained through the practical implementation of the inventive structuring technique previously described.

The copolymers used for these examples consist of azoic molecules of (N-ethyl-N-hydroxyethyl-4-(4′-cyanophenylazo)phenylamine (DOPR) and 4-(N-(2-hydroxyethyl)-N-ethyl-)amino-4′-nitroazobenzene (DRI) grafted onto a polymer backbone, and of methyl polymethacrylate (PMMA), transparent in the visible range) with a mole percentage of 35% (DOPRMA/MMA 35/65, DRIMA/MMA 35/65).

The structures of the copolymers used are given below:

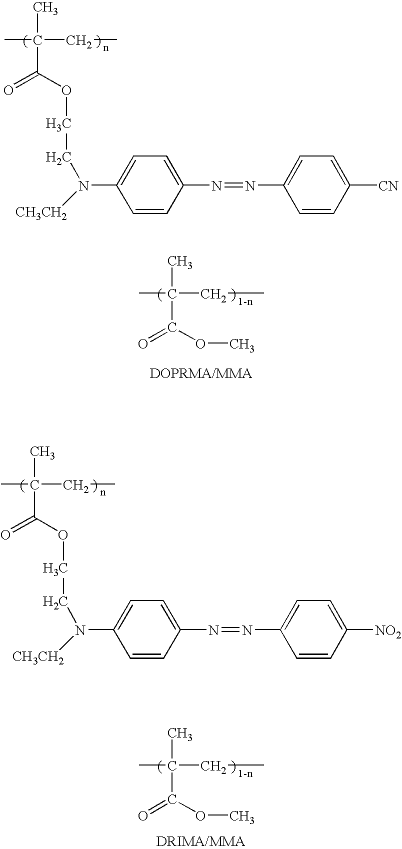

The dye molecules used for these examples are azoic molecules of “push/pull” type, i.e. having acceptor and donor groups separated by two benzene cycles bound by a double nitrogen bond (N═N). These molecules are highly absorbing in the visible range. In addition, they have the advantage of being isomerisable (Cis-Trans isomerisation), the repeated changeovers of the molecule from one form to the other inducing photoinduced molecular movements (rotation and translation) inside the polymer matrix.

The present invention is not limited however to this type of particular molecule. More generally, the present invention can be implemented with molecules of the type illustrated in appended FIG. 3 or any other molecule having photoinduced isomerisation or having photoinduced molecular movements.

FIG. 3 shows molecules having a donor group of electrons chosen from the group comprising CH₃, OCH₃, NH₂, NR₁R₂ in which R1 and R2 are aliphatic chains [e.g. N(CH₃)₂] and an acceptor group of electrons chosen from the group comprising CN, CHO, COCH₃, NO₂, separated by two benzene cycles bound by a double nitrogen-nitrogen bond.

As a variant, the electron transmitter assembly shown FIG. 3 of two benzene cycles bound by a double nitrogen-nitrogen bond may be replaced by any other group having sufficiently fast reversible isomerisation, typically less than 1 ms.

In the conducted experiments, the thickness of the films was 500 nm. The experiments were conducted with a 514 nm ray of an Argon laser. The intensity of the incident laser beam was 1 W/cm², the irradiation time 90 minutes and polarisation of the laser beam was linear. The rotational frequency of the motor was 5 hertz.

The three images reproduced in appended FIGS. 4, 5 and 6 were obtained using an atomic force microscope (AFM) under the above-indicated conditions, i.e. using the DOPRMA/MMA copolymer for FIGS. 4 and 5 and the DRIMA/MMA copolymer for FIG. 6. They show the photoinduced structures which can be obtained with the inventive technique.

The modulation amplitude of the structures can reach 100 nm, the structures having modulation amplitudes that are greater the higher the quantity of absorbed energy. Nonetheless, the experiment shows that in terms of power density there is a threshold below which no structure develops. Also, beyond a certain dose of absorbed energy the modulation amplitudes become saturated.

The period of the observed structures is in the order of the irradiation wavelength and does not vary in relation to the material used.

The structuring method of the present invention allows the coupling, in the plane of the polymer film, of a light beam of normal incidence and offers interesting prospects in particular regarding the optimisation of the efficacy of solar photovoltaic cells. In this context, it is noted for example that if it is desired to couple a given wavelength in the plane of the film, all that is required is to apply this wavelength directly during the structuring (the absence of a mask or other intermediate process abolishes any need for special adjustment).

The geometry of the induced structures varies in relation to different parameters, in particular:
the irradiation wavelength, the periodicity of the structures obtained being in the same order of magnitude as the irradiation wavelength,
the power of the laser beam and the exposure time which act on the amplitude of modulation,
the relative position of the irradiation wavelength with respect to the absorption band of the material,
the frequency of rotation of the sample,
the type of copolymer used,
the polarisation of the laser beam,
the position of the incident laser beam on the sample with respect to the axis of rotation of the motor (“off-axis” rotation or “on-axis” rotation).

By way of illustration:
the image in FIG. 4 (hexagonal organisation) was obtained after irradiating a sample of DOPRMA/MMA with a laser beam centred on the axis of rotation, the polarisation of the laser being linear,
the image in FIG. 5 (fringes) was obtained after irradiating a sample of DOPRMA/MMA with a laser beam that was offset with respect to the axis of rotation, laser polarisation being linear. The orientation of the fringes varies continuously according to the position of the analysed area with respect to the axis of the support (position on the “illumination ring”).
the image in FIG. 6 (organisation not having any priority direction) was obtained after irradiating a sample of DRIMA/MMA with a laser beam centred on the axis of rotation, laser polarisation being linear. Depending on the frequency of rotation of the sample, structures identical to those in FIG. 6 can also be obtained when irradiating an identical sample with a laser beam offset from the axis of rotation as illustrated FIG. 2.

When circular polarisation is used, irrespective of the frequency of rotation and the type of irradiation (“on axis” as illustrated FIG. 1 or “off-axis” as illustrated FIG. 2), the experiments led to identical induced structures to those in FIG. 6.

The structuring technique proposed by the present invention has the advantage of drawing benefit from the properties of the polymer or hybrid materials: low production cost coupled with the possible depositing of films on surfaces larger than several square centimetres. In addition, the use of a single laser beam implies low set-up costs.

Compared with already existing methods known in the prior art, the all-optical structuring method of the present invention has the following particular advantages;
great ease of implementation, no mask fabrication is required, no precise alignment needs to be made (only near-normal incidence of the laser beam on the polymer or hybrid film is necessary) due to the use of a single laser beam,
the possible structuring of the material on large surfaces (several cm²), simply by increasing the size of the beam using a lens system or by conducting “off-axis” irradiation of the polymer film,
structure diversity: the geometry of the induced structures and their amplitudes can be controlled by varying experimental parameters: frequency of rotation of the sample, quantity of energy absorbed by the sample, polarisation of the laser beam, position of the incident laser beam on the sample with respect to the axis of rotation of the motor (“off-axis” or “on-axis” of rotation), the type of molecule used,
possible working in a free environment without the need for a clean room.

The present invention finds particular application in the area of organic optoelectronics, e.g.:
to optimise light-emitting devices (by uncoupling on structures of initially guided light),
to optimise photovoltaic cells (by optimizing absorption of the incident solar spectrum and coupling in the plane of the film).

The present invention can generally give rise to numerous applications.

The structures obtained under the present invention can also be used as substrate for the conforming deposit of layers of other materials having different optical, electronic or mechanical properties but which will maintain the same structural properties.

The structures obtained under the present invention may also be used as replication mask using different techniques known by persons skilled in the art, such as contact techniques (embossing, stamping) or optical techniques (of photolithography type).

In the above-illustrated examples the optical polarisation of the laser beam was linear or circular but could have been elliptical.

### BIBLIOGRAPHICAL REFERENCES

[1] L. Rocha, C. Fiorini-Debuisschert, C. Denis, P. Maisse, P. Raimond, B. Geffroy, J. M. Nunzi, Organic nanophotonics, F. Charra et al (eds.), Kluwer Academic Publishers, 405, 2003.
[2] Y. Xia, J. A. Rogers, K. E. Paul, G. M. Whitesides, Unconventional methods for fabricating and patterning nanostructures, Chem. Rev., 1999, 99, 1823 and cited references.
[3] P. Rochon, E. Batalla, A. Natansohn, Optically induced surface gratings on azoaromatic polymer films, Appl. Phys. Lett, 1995, 66, 2, 136.
[4] D. Y. Kim, S. K. Tripathy, L. Li, J. Kumar, Laser induced holographics surface relief gratings on nonlinear optical polymer films, Appl. Phys. Lett., 1995, 66, 10, 1166.
[5] A. E. Siegman, P. M. Fauchet, Stimulated Wood's anomalies on laser-illuminated surfaces, IEEE J. Quantum Elec., 1986, 22, 1384.
[6] M. Bolle, S. Lazare, M. Le Blanc, A. Wilmes, Submicron periodic structures produced on polymer surfaces with polarized excimer laser ultraviolet radiation, Appl. Phys. Lett., 1992, 60, 6, 674.
[7] C. Hubert, C. Fiorini-Debuisschert, P. Raimond, J. M. Nunzi, Adv. Mat., 14, 729, 2002.
[8] C. Hubert, C. Fiorini-Debuisschert, P. Raimond, J. M. Nunzi, Organix Nanophotonics, 317-325, F. Charra et al (Eds), Kluwer Academic Publishing 2003.

1-18. (canceled)

19. Method for fabricating periodic structures on a surface of an organic material or hybrid organic-inorganic material of sol-gel type, characterized in that it comprises a step which consists of directly illuminating the material with a laser beam having a uniform intensity profile under near-normal incidence, while causing relative movement between said material and the laser beam.

20. Method as in claim 19, characterized in that the relative movement between the material and the laser beam corresponds to a relative rotation.

21. Method as in claim 19, characterized in that the relative movement between the material and the laser beam relates to a rotation of the material.

22. Method as in claim 19, characterized in that the laser beam during irradiation covers a surface which corresponds to several cm² of the material.

23. Method as in claim 20, characterized in that the laser beam (10) is centered on a rotation spindle (22).

24. Method as in claim 19, characterized in that optical polarisation of the laser beam is linear, or circular, or elliptical.

25. Method as in claim 19, characterized in that a lens system is inserted in a pathway of the laser beam to increase and control size of impact of the laser beam on the material.

26. Method as in claim 20, characterized in that the laser beam (10) is off-centred with respect to a rotation spindle (22) and at least substantially parallel to it.

27. Method as in claim 19, characterized in that the irradiated material consists of a polymer or sol-gel backbone on which absorbent molecules are grafted.

28. Method as in claim 19, characterized in that the irradiated material is formed of molecules having a donor group of electrons and an acceptor group of electrons.

29. Method as in claim 19, characterized in that the irradiated material is formed of molecules having a donor group of electrons and an acceptor group of electrons separated by a transmitter group of electrons having photoinduced isomerisation or having photoinduced molecular movements.

30. Method as in claim 19, characterized in that the irradiated material is formed of azoic molecules.

31. Method as in claim 19, characterized in that the irradiated material is formed of molecules having a donor group of electrons and an acceptor group of electrons separated by two benzene cycles bound together by a double nitrogen-nitrogen bond.

32. Method as in claim 19, characterized in that the irradiated material is formed of molecules having a donor group of electrons chosen from the group comprising CH₃, OCH₃, NH₂, NR₁R₂ in which R1 and R2 are aliphatic chains, and an acceptor group of electrons chosen from the group comprising CN, CHO, COCH₃, NO₂.

33. Method as in claim 19, characterized in that the irradiated material is chosen from the group comprising azoic molecules of (N-ethyl-N-hydroxyethyl-4(4′-cyanophenylazo)phenyalamine) (DOPR) and 4-(N-(2-hydroxyethyl)-N-ethyl-)amino-4′-nitro-azobenzene (DR1) grafted onto a polymer backbone.

34. Method as in claim 33, characterized in that the polymer backbone is methyl polymethacrylate.

35. Method as in claim 19, characterized in that a wavelength of the laser beam lies within or is close to an absorption band of the irradiated material.

36. Method as in claim 19, characterized in that it uses means able to control at least one of the parameters chosen from the group comprising:
an irradiation wavelength
a power of the laser beam and exposure time
a relative position of an irradiation wavelength with respect to an absorption band of the material,
a frequency of rotation of the material,
a polarisation of the laser beam,
a position of the incident laser beam on the material with respect to an axis of rotation of a motor.
a type of molecule chosen.
